(19) United States
(12) Patent Application Publication
(10) Pub. No.: US 2024/0397966 A1
(43) Pub. Date: Dec. 5, 2024

(54) POWDERED WHIPPING AGENT HAVING IMPROVED FUNCTIONALITY

(71) Applicant: FrieslandCampina Nederland B.V., Amersfoort (NL)

(72) Inventors: Elisabeth Wilhelmina Maria DE JONG, Wageningen (NL); Thorsten Andreas BRIEGER, Wageningen (NL); Gunter Alfred SAUER, Wageningen (NL)

(73) Assignee: FrieslandCampina Nederland B.V., Amersfoort (NL)

(21) Appl. No.: 18/806,349

(22) Filed: Aug. 15, 2024

Related U.S. Application Data
(63) Continuation of application No. PCT/EP2023/053929, filed on Feb. 16, 2023.

(30) Foreign Application Priority Data
Feb. 17, 2022 (EP) 22157209.2

(51) Int. Cl. A23D 7/005; A23L 29/10; A23P 10/47; A23P 30/40

(52) U.S. Cl. CPC A23D 7/0053; A23L 29/10; A23P 10/47; A23P 30/40

(57) ABSTRACT

The invention relates to a powdered whipping agent for preparing whipped topping, the whipping agent comprising, by weight of the whipping agent, at least 20 wt. % but less than 57 wt. % fat or oil or mixtures thereof; 1.0-5.5 wt. % of an alpha-tending emulsifier, selected from the group consisting of lactic acid esters of mono- and/or diglycerides of fatty acids, acetic acid esters of mono- and/or diglycerides of fatty acids, propylene glycol monostearate, and mixtures thereof; 0.2-2.0 wt. % of nonionic mono- and/or diglycerides of fatty acids having at least one acyl chain of 14-20 carbon atoms; 1.0-5.0 wt. % proteinaceous emulsifier, 25.5-75.0 wt. % carbohydrates and 0.1-4.0 wt. % moisture. The invention further relates to a method for preparing such a powdered whipping agent. The invention also relates to a method for preparing a whipped topping using the powdered whipping agent according to the invention. The invention further relates to the use of a powdered whipping agent according to the invention for the preparation of a whipped food product.

### RELATED APPLICATIONS

This application is a continuation of International PCT Application PCT/EP2023/053929 filed Feb. 16, 2023, which application claims priority to European Patent Application No. 22157209.2 filed Feb. 17, 2022, the entire contents of which are incorporated herein by reference.

### FIELD OF THE INVENTION

The present invention relates to a powdered whipping agent providing an enhanced whipped food texture, and to a method of preparing such a powdered whipping agent. The invention further relates to the use of such a whipping agent for preparing a whipped food product.

### BACKGROUND TO THE INVENTION

Whipping agents are widely used in the food industry and at home. Whipping agents serve to incorporate gas such as air into food products by whipping them with an edible liquid, for instance milk or water. The obtained whipped products can then be used as, for instance, instant desserts, cake fillings, ice cream fillings and the like.

Whipping agents are typically spray-dried emulsions, comprising fat, one or more emulsifiers, carbohydrates and protein. A typical composition of such a whipping agent contains about 30-40 wt. % (vegetable) fat, 9-18 wt. % emulsifier, 30-50% carbohydrates, and about 3-8 wt. % protein.

An important function of whipping agents is the ability to be easy to whip, and produce a high enough overrun and firmness to keep the whipped product stable (i.e. shape retention) for a longer period of time. This can for instance be hours and even up to days.

Further, whipped or aerated food products made with conventional whipping agents should have an acceptable sensory profile.

The typical sensory profile of conventional whipping agents can be described as giving a sticky and long lingering mouthfeel and lacks a dairy experience in both taste and mouthfeel. This is unlike whipped dairy cream, which is characterized by a sensory profile with a creamy taste and mouthfeel and is dissolving more quickly in the mouth.

US2015/104556 relates to a spray dried cream base powder which can be used as an alternative to dairy creams and other liquid cooking creams. The powdered cooking cream composition comprises 20-60% by weight fat, 1-5% by weight one or more proteins, 0.5-5% by weight one or more emulsifier systems, 1-6% by weight native/modified starch, 1-5% by weight water and the balance is made up of non-starchy carbohydrates, buffering agents and stabilizers. The composition can be used to prepare curries, gravies, soups, sauces, and to develop processed food products such as soft serve ice cream, whipped toppings, mousse, instant dry soup mix and milk based puddings.

GB 1,091,270 relates to fatty mixtures and especially to confectionary toppings similar to whipped cream and to mixtures suitable for use in preparing such toppings. Use is made of an emulsifier of the type glycerol diester in which one of the acid radicals is that of acetic acid and the other that of a fatty acid having 12 to 24 carbon atoms, in a topping mixture containing fat and a water-dispersible protein.

U.S. Pat. No. 3,764,346 relates to a spray dried mixture prepared from (1) a polyglycerol partial ester of a higher fatty acid, (2) water soluble starch, modified starch, dextrin, sucrose, glucose, maltose, lactose, gum Arabic, larch gum or corn syrup solids having a D.E. value of at least 4, and (3) an essential oil.

The need therefore exists to provide an improved powdered whipping agent providing to the whipped product sensory properties that are more in line with whipped dairy cream than the conventional whipping agents, and which also has a good overrun, and good stability over time.

### SUMMARY OF THE INVENTION

It has now been found that the powdered whipping agent according to the invention provides an enhanced sensory effect to whipped food products, compared to traditional whipping agents. With the powdered whipping agent according to the invention a surprisingly good texture and mouthfeel, which are important sensory aspects, could be obtained and at the same time, good whipping properties, such as good overrun and foam stability, were achieved as well. Accordingly, in a first aspect, the invention relates to a powdered whipping agent suitable for preparing a whipped topping, the whipping agent comprising, by weight of the whipping agent:
a) at least 20 wt. % but less than 57 wt. % fat or oil or mixtures thereof;
b) 1.0-5.5 wt. % of an alpha-tending emulsifier, selected from the group consisting of lactic acid esters of mono- and/or diglycerides of fatty acids, acetic acid esters of mono- and/or diglycerides of fatty acids, propylene glycol monostearate, and mixtures thereof;
c) 0.2-2.0 wt. % of nonionic mono- and/or diglycerides of fatty acids having at least one acyl chain of 14-20 carbon atoms;
d) 1.0-5.0 wt. % proteinaceous emulsifier;
e) 25.5-75.0 wt. % carbohydrates;
f) 0.1-4.0 wt. % moisture.

In a second aspect, the invention relates to a method for preparing a powdered whipping agent according to the invention, comprising the steps of:
a) Preparing a mixture of water and fat or oil or mixtures thereof, alpha-tending emulsifier, nonionic mono- and/or diglyceride of fatty acids having at least one acyl chain of 14-20 carbon atoms, proteinaceous emulsifier, carbohydrates, and optionally other components;
b) Homogenizing the mixture to obtain an emulsion; and
c) Spray drying the emulsion to obtain the powdered whipping agent.

In a third aspect, the invention relates to a method for preparing a whipped food product having an overrun of 100-400% comprising whipping the composition of the invention in a food acceptable liquid.

In a fourth aspect, the invention further relates to the use of the powdered whipping agent according to the invention for the preparation of a whipped food product, in particular a dessert, cake or pie filling, ice cream filling, crème Chantilly, or mousse.

### DETAILED DESCRIPTION

### Definitions

The term “powdered whipping agent” us used herein has its conventional meaning and refers to a dry composition which is preferably spray-dried, and may be added to an edible liquid such as water or milk, after which it may be whipped to form a stable and firm foam.

The term “fat or oil” us used herein has its conventional meaning and refers to triglycerides, being fatty acid esters of glycerol, the fatty acids may be saturated or unsaturated.

The term “alpha-tending emulsifier” has its conventional meaning and refers to organic acid esters of mono- and/or diglycerides wherein most of said esters are present, or are able, to crystallize in their alpha crystalline form (see e.g. Gerard L. Hasenhuettl, Food emulsifiers and their applications, 2008 p. 305.

The term “nonionic mono- and/or diglycerides” has its conventional meaning and refers to mono- and/or di-esters of fatty acids and glycerol, which contain substantially no ionic or ionizable residues.

The term “Overrun” is defined by means of the following formula:

$$d / ( b - a ) \times 100 - 100 = \% overrun .$$

wherein:
a=weight of empty cup
b-weight of cup filled with whipped product
d=cup volume.

Foam firmness is the force in grams required to penetrate the foam. It is preferably measured with a texture analyzer TA-XT2i of Stable Micro Systems using the following settings: speed 1 mm/s, time 15 seconds, where foam firmness is the value measured after 10 seconds of penetration.

Weight percentages given in the description of the invention are drawn to the weight of the powdered whipping agent, unless otherwise specified.

Conventional powdered whipping agents normally have fat or oil content of around 30-40 wt. % (see f. i. Hasenhuttl 208, page 230), and an alpha-tending emulsifier content of around 9-18 wt. %, about 30-50 wt. % carbohydrates and about 3-8 wt. % protein, which makes them suitable for providing a whipped topping that shows good overrun and foam stability. However, as stated before, the sensory aspect can be qualified as a sticky, long lingering mouthfeel and lack of dairy experience in both taste and mouthfeel, giving a sensation far away from dairy cream and therefor the “creamy” sensation is absent.

By using the composition according to the invention, major progress has now been made in improving the sensory attributes of whipped toppings.

In the art, it has never been contemplated or suggested to deviate substantially from this conventional powdered whipping agent composition. Rather, a solution to solve the sensory aspect was sought by using for instance different fat or oils, or fractions thereof, or adding flavor ingredients.

It now appeared that deviating from this traditional view by applying a lower amount of the alpha-tending emulsifier unexpectedly resulted in enhanced sensory aspects whilst still excellent whipping properties (overrun and foam stability) were achieved.

The whipping agent according to the invention comprises more than 20 wt. %, but less than 57 wt. % fat or oil or mixtures thereof. The feature “less than 57 wt. %” therefor means that the value of 57 wt. % is excluded from the above range. The whipping agent according to the invention preferably comprises more than 25 wt. %, more preferably more than 30 wt. %, most preferably more than 33 wt. % fat or oil or mixtures thereof. Preferably, the whipping agent comprises less than 56 wt. %, more preferably less than 55 wt. %, even more preferably less than 53 wt. %, most preferably less than 50 wt. % of fat or oil, or mixtures thereof.

In a preferred embodiment, the whipping agent comprises 30-55 wt. %, more preferably 33-50 wt. % most preferably 34-48 wt. % fat or oil or mixtures thereof. The fat or oil in the whipping agent may comprise one or more vegetable oils. Preferably, the fat or oil is selected from the group consisting of palm oil, palm kernel oil, coconut oil, more preferably fully refined coconut oil, palm kernel stearin, sunflower oil, rapeseed oil, soybean oil, corn oil, shea oil, and/or mixtures thereof.

The fat or oil may be a natural fat or oil. The fat or oil may be non-hardened, or fully hardened, or mixtures thereof.

Hardened fat or oil is defined as fat or oil in which substantially all the double carbon-carbon bonds is the fatty acid residues of the fat or oil have been saturated by hydrogenation.

It is preferred that the oil or fat in the whipping agent comprises more than 80 wt. % of vegetable fat or oil, more preferably more than 90 wt. %, most preferably more than 95 wt. %, based on the weight of the fat or oil present. In a most preferred embodiment, all the fat or oil is vegetable fat or oil.

The fat or oil may optionally comprise some milk fat and/or butter oil. However, it was found that a too high amount of milk fat or butter oil resulted in a too soft and less firm whipped foam. Accordingly, preferably, the fat or oil comprises less than 20 wt. % of milk fat and/or butter oil, preferably less than 15 wt. %, most preferably less than 10 wt. %, based on the weight of the fat or oil present in the whipping agent.

The powdered whipping agent according to the invention preferably comprises 1.5-5.5 wt. % alpha-tending emulsifier selected from the group consisting of lactic acid esters of mono- and/or diglycerides of fatty acids, acetic acid esters of mono- and/or diglycerides of fatty acids, propylene glycol monostearate, and mixtures thereof, more preferably 1.6-5.0, wt. %, even more preferably 1.7-4.7 wt. %, still even more preferably 1.9-4.5 wt. %, and most preferably between 2.0 and 4.0 wt. % based on the weight of the whipping agent.

Preferably, the alpha-tending emulsifier in the whipping agent is a lactic acid ester of mono- and/or diglycerides of fatty acids or an acetic acid ester of mono- and/or diglycerides of fatty acids, or mixtures thereof. Most preferably, the alpha tending emulsifier is a lactic acid ester of mono- and/or diglycerides of fatty acids.

The fatty acids in the alpha-tending emulsifiers are preferably saturated, more preferably fully saturated.

It appeared that the presence of a second emulsifier next to the alpha-tending emulsifier further improved the whipping ability in overrun, foam stability and mouthfeel of whipped food products using the whipping agent according to the invention.

Accordingly, the whipping agent according to the invention preferably comprises 0.3-1.9 wt. %, more preferably 0.4-1.7 wt. %, most preferably 0.5-1.5 wt. % of nonionic mono- and/or diglycerides of fatty acids having at least one acyl chain of 14-20 carbon atoms, based on the weight of the powdered whipping agent. Preferably, the nonionic emulsifier is a monoglyceride of fatty acids having at least one acyl chain of 14-20 carbon atoms, based on the weight of the powdered whipping agent.

In one preferred embodiment, the nonionic mono- and/or diglycerides of fatty acids having at least one acyl chain of 14-20 carbon atoms comprise an unsaturated acyl chain. Preferably, the unsaturated acyl chain is a C16 or C18 acyl chain, more preferably a C18 chain, even more preferably an oleic acid chain. An oleic acid chain is a C18:1 chain. Most preferably, the nonionic mono- and/or diglycerides of fatty acids having at least one acyl chain of 14-20 carbon atoms comprising an unsaturated acyl chain is a glycerol mono-oleate. The latter glyceride may be abbreviated as “GMO”.

In another embodiment, the nonionic mono- and/or diglycerides of fatty acids having at least one acyl chain of 14-20 carbon atoms comprise a saturated acyl chain. Preferably, the nonionic mono- and/or diglycerides of fatty acids having at least one acyl chain of 14-20 carbon atoms comprising a saturated acyl chain comprise a C18 chain.

More preferably, the nonionic mono- and/or diglycerides of fatty acids having at least one acyl chain of 14-20 carbon atoms comprising a saturated acyl chain comprising a C18 chain is glycerol monostearate. The latter glyceride may be abbreviated as “GMS”.

It has now been found that the wt./wt. ratio of fat or oil to alpha-tending emulsifier in the whipping agent according to the invention is important. Where traditional whipping agents have for instance around 35 wt. % fat or oil and e.g. 16 wt. % alpha-tending emulsifier, forming a wt./wt. ratio of fat or oil to alpha tending emulsifier of about 2, the whipping agent of the invention has a much higher wt./wt. ratio of fat or oil to alpha tending emulsifier.

Accordingly, the weight/weight ratio fat or oil to alpha-tending emulsifier in the powdered whipping agent is preferably 10 or higher. More preferably, the weight/weight ratio fat or oil to alpha-tending emulsifier in the powdered whipping is 30 or lower, more preferably lower than 25.

More preferably, the weight/weight ratio fat or oil to alpha-tending emulsifier in the powdered whipping lies between 10 and 30, even more preferably between 11 and 25, most preferable between 11.5 and 20.

In an embodiment, in the powdered whipping agent, the weight/weight ratio of alpha-tending emulsifier, selected from the group consisting of lactic acid esters of mono- and/or diglycerides of fatty acids, acetic acid esters of mono- and/or diglycerides of fatty acids and propylene glycol monostearate to nonionic mono- and/or diglycerides of fatty acids having at least one acyl chain of 14-20 carbon atoms, is preferably between 1.5 and 10, more preferably between 1.7 and 6.0, most preferably between 2.0 and 4.0.

The powdered whipping agent according to the invention preferably comprises 0.1-1.5, more preferably 0.2-1.2, most preferably 0.4-1.1 wt. % of additional components selected from the group of stabilizers, hydrocolloids, flavoring agents and coloring agents, and combinations thereof.

Suitable stabilizers may be selected from group of phosphates, diphosphates, polyphosphates, hexametaphosphates, their sodium or potassium salts, and mixtures thereof. Preferably, stabilizers may be present in an amount of 0.7-1.5 wt. % based on the weight of the whipping agent. Preferred is dipotassium phosphate.

Hydrocolloids may be selected by the skilled person as required, and can suitably comprise e.g. locust bean gum, gelatin, gellan gum, xanthan gum, guar gum, gum Arabic, starch, modified starch, gum karaya, gum tragacanth, cellulose gum, carrageenan, agar, alginate, pectin, carboxymethylcellulose, hydroxy methylcellulose, and mixtures thereof. For the purpose of the invention, gelatin is not comprised in the definition of proteinaceous emulsifier.

The powdered whipping agent preferably comprises 1.5-4.5, more preferably 2.0-4.0 wt. % proteinaceous emulsifier.

In the powdered whipping agent according to the invention, at least 50 wt. % of the proteinaceous emulsifier is a milk protein or a plant protein or combinations thereof.

Suitable milk proteins preferably comprise milk powder, skim milk powder, casein, casein salts such as sodium, potassium, and/or calcium caseinate, whey protein, whey protein concentrate, and mixtures thereof. More preferably, the milk protein comprises caseinate, most preferably sodium caseinate.

Suitable plant proteins preferably comprise soy protein, pea protein, oat protein, wheat protein, and potato protein, their hydrolysates, and mixtures thereof.

Preferably more than 50 wt. %, more preferably more than 75 wt. %, even more preferably more than 90 wt. % of the of the proteinaceous emulsifier in the whipping agent is a milk protein. Most preferably, all the proteinaceous emulsifier is milk protein.

The whipping agent according to the invention preferably comprises 30-70 wt. %, more preferably 35-65 wt. %, most preferably 40-60 wt. % carbohydrates. Carbohydrates used in the whipping agent according to the invention preferably comprise hydrolyzed starches, glucose syrup, maltodextrins, lactose and mixtures thereof.

In a preferred embodiment, the carbohydrates comprise glycose syrup.

Preferably, the carbohydrates in the whipping agent according to the invention comprise lactose. Addition of lactose appeared to support the sensory profile in terms of dairy taste of the whipped product.

In a more preferred embodiment, the carbohydrates comprise a mixture of glucose syrup and lactose.

More preferably, 20-70 wt. % of the carbohydrates comprise lactose, most preferably 25-50 wt. %

In a most preferred embodiment, the carbohydrates in the whipping agent comprise a mixture of glucose syrup and lactose, wherein 20-70 wt. %, more preferably 25-50 wt. % of the total weight of glucose syrup and lactose, is lactose.

In a second aspect, the invention relates to a method for preparing a powdered whipping agent according to the invention, comprising the steps of:
a) Preparing a mixture of water and fat or oil or mixtures thereof, alpha-tending emulsifier, nonionic mono- and/or diglyceride of fatty acids having at least one acyl chain of 14-20 carbon atoms, proteinaceous emulsifier, carbohydrates, and optionally other components;
b) Homogenizing the mixture to obtain an emulsion; and
c) Spray drying the emulsion to obtain the powdered whipping agent.

The mixture in step a. comprises at least 20 wt. % but less than 57 wt. % fat or oil or mixtures thereof; 1.0-5.5 wt. % an alpha-tending emulsifier, selected from the group consisting of lactic acid esters of mono- and/or diglycerides of fatty acids, acetic acid esters of mono- and/or diglycerides of fatty acids, propylene glycol monostearate, and mixtures thereof; 0.2-2.0 wt. % of nonionic mono- and/or diglycerides of fatty acids having at least one acyl chain of 14-20 carbon atoms; 1.0-5.0 wt. % proteinaceous emulsifier; and 25.5-75.0 wt. % carbohydrates, based on dry weight of the components in the mixture.

Thus, preferably, in step (a) the amount of the components fat or oil, the alpha-tending emulsifier, the nonionic mono- and/or diglyceride of fatty acids having at least one acyl chain of 14-20 carbon atoms; the proteinaceous emulsifier, and the carbohydrates are chosen such that one arrives at the composition according to claim 1.

Preferably, the mixture in step a. comprises 25-56 wt. % fat or oil; 1.5-5.5 wt. % an alpha-tending emulsifier, selected from the group consisting of lactic acid esters of mono- and/or diglycerides of fatty acids, acetic acid esters of mono- and/or diglycerides of fatty acids, propylene glycol monostearate, and mixtures thereof; 0.3-1.9 wt. % of nonionic mono- and/or diglycerides of fatty acids having at least one acyl chain of 14-20 carbon atoms; 1.2-4.5 wt. % proteinaceous emulsifier; and 30.0-70.0 wt. % carbohydrates, based on dry weight of the components in the mixture.

Furthermore, the components used in the method of the invention:
fat or oil;
lactic acid esters of mono- and/or diglycerides of fatty acids, acetic acid esters of mono- and/or diglycerides of fatty acids, propylene glycol monostearate;
nonionic mono- and/or diglycerides of fatty acids having at least one acyl chain of 14-20 carbon atoms;
proteinaceous emulsifier;
carbohydrates;
with their preferred, more preferred and most preferred embodiments and/or amounts, may preferably be used as described for the powdered whipping agent according to the invention.

Preferably, step a. is carried out a temperature of between 65° C.-75° C.

The emulsifying step is preferably a high-pressure homogenization, more preferably a two-step high pressure homogenization. The homogenization pressure preferably comprises a range of 80-200 bar, more preferably 100-150 bar for the first homogenization step. The second homogenization step preferably comprises a range of 20-60 bar, more preferably 25-55 bar.

The spray-drying step is carried out according to industrial practice known in the art.

It is preferred that in step a, the carbohydrate comprise a source of lactose. It is further preferred that the source of lactose comprises 60-100 wt. %, more preferably 65-95 wt. %, most preferably 70-90 wt. % of lactose by weight of the source of lactose.

In a preferred embodiment, the source of lactose comprises or is whey permeate, more preferably sweet whey permeate. It is preferred that the whey permeate is in powder-form.

Whey permeate, as the skilled person is aware, is a by-stream from ultrafiltration of whey, a process in which whey proteins are separated from whey, resulting in a whey protein-enriched stream, and a lactose-rich stream. As stated herein before, addition of lactose supports the sensory profile in terms of dairy taste of the whipped product.

In a third aspect, the invention relates to a method for preparing a whipped food product having an overrun of 100-400%, more preferably 150-350%, comprising whipping the composition according to the invention in a food acceptable liquid.

The food acceptable liquid may comprise milk or water, or mixtures thereof.

The food acceptable liquid may further comprise, sweeteners, such a sucrose and/or dextrose, thickeners such as locust bean gum, gelatin, gellan gum, xanthan gum, guar gum, gum Arabic, starch, modified starch, gum karaya, gum tragacanth, cellulose gum, carrageenan, agar, alginate, pectin, carboxymethylcellulose, hydroxy methylcellulose and mixtures thereof, flavors, coloring agents etc.

Preferably, the whipping is done at a temperature between 0-15° C.

The whipped food product can suitably be, or used in, for instance, a cake or pie filling, dessert, mousse, crème Chantilly, or ice-cream.

The whipped food product preferably comprises at least 8 wt. %, more preferably at least 15 wt. %, most preferably 20-35 wt. % of the whipping agent according to the invention, based on the weight of the whipped food product.

In a fourth aspect, the invention relates to the use of the powdered whipping agent according to the invention for the preparation of a whipped food product, in particular a dessert, cake or pie filling, ice cream filling, crème Chantilly, or mousse.

The invention will now be illustrated by the following non-limiting examples.

### EXPERIMENTAL SECTION

### Examples

### Example 1

The following examples were prepared. The final composition is given in table 1 below.

TABLE 1
Composition of spray dried whipping agents of the invention.

| | Sample 1 | Sample 2 | Sample 3 |
|---|---|---|---|
| Oil: PKO/coconut/AMF | 35.6 | | |
| (wt./wt./wt. % 37/55/8) | | | |
| Oil: PKO/coconut | | 35.0 | 47.5 |
| (wt./wt. % 41/59) | | | |
| Glucose syrup | 55.7 | 37.3 | 24.6 |
| Lactose + sweet whey | | 18.0 | 18.2 |
| permeate (wt. ratio 1:1) | | | |
| Alpha-tending emulsifier (Lactem) | 2.0 | 3.0 | 3.0 |
| Nonionic mono-/diglyceride (GMO) | 1.0 | 1.0 | 1.0 |
| Dipotassium Phosphate | 1.0 | 1.0 | 1.0 |
| Sodium caseinate | 3.2 | 3.2 | 3.2 |
| Moisture | 1.5 | 1.5 | 1.5 |
| Wt./Wt. ratio [fat]/[alpha-tending | 17.8 | 11.7 | 15.8 |
| emulsifier] | | | |

PKO = palm kernel oil, FR Palmkernel 37/SG from Cargill.
coconut = fully refined coconut oil from Cargill.
AMF = anhydrous milk fat from FrieslandCampina Butter.

### Preparation Method Sample 1.

First, an aqueous mixture at 70° C. was prepared by mixing 40.5 kg of water, 45.5 kg of glucose syrup DE28 (Roquette), 2.7 kg of sodium caseinate (EM 7, FrieslandCampina Ingredients), and 0.8 kg of dipotassium phosphate.

Then, 10.5 kg of palm kernel oil (FR Palmkernel 37/SG from Cargill), 15.4 kg of fully refined coconut oil (Cargill), 2.2 kg of Anhydrous Milk Fat (AMF, FrieslandCampina Butter), 1.6 kg of alpha tending emulsifier (Lactem P22 SG, DuPont), and 0.8 kg of non-ionic mono-/diglyceride (GMO, Myverol 18-35 PL SG, Kerry) were mixed and added to the aqueous phase and stirred. Subsequently, the aqueous/oily phase was homogenized in a two-step homogenization using a pressure of 100/50 Bar to form an emulsion and was pasteurized at a temperature of 78° C. After homogenization, the emulsion was spray-dried at approximately (T (in) 150° C. and T (out) 85° C.

Samples 2 and 3 were Prepared in a Similar Fashion as Sample 1, with Adjustment of the Ingredients, so as to Obtain Powdered Whipping Agent with Compositions as Shown in Table 1.

A conventional whipping agent obtainable in the market (Monte DP 570, FrieslandCampina Professional) was used as a reference.

The composition is given below:

| | Reference Monte DP570 |
|---|---|
| Vegetable oil (PKO, hydrogenated | 35.1 |
| and fractionated) | |
| Glucose syrup | 40.8 |
| Emulsifier (Acetem E472a + | 18.9 |
| mono- and diglycerides) | |
| Sodium caseinate | 2.8 |
| Dipotassium Phosphate | 1.0 |
| Moisture | 1.5 |
| Wt. Ratio [fat]:[emulsifier] | <5 |

The other reference product against which was tested, was whipped dairy cream. This was obtained by whipping DEBIC 32% fat cream (FrieslandCampina Professional) together with 10 wt. % sugar: 460 grams of liquid cream was whipped for 7 minutes with 40 grams icing sucrose at 6° C. in a Hobart mixer, set at level 2 speed, followed by level 3 speed (about 30 seconds) until the cream had reached the desired structure, and an overrun of about 84% was obtained.

### Example 2

### Functionality and Sensory Testing of the Whipping Agents and Whipped Dairy Cream

The above-mentioned whipping agents were used for the preparation of whipped products, and were tested for whippability (overrun) and foam firmness as follows: In a mixer (KitchenAid), 150 g of the above-mentioned whipping agents were blended with 40 g of icing sugar and 350 ml water of 5-7° C. Mixing started for two minutes at low speed (level 4) and continued for two and a half minutes at the maximum speed (level 10).

After whipping, the overrun and firmness were determined.

Overrun is determined as follows:

The foam obtained was brought into an overrun cup, with a pre-defined volume and weight. The % overrun was calculated by means of the following formula:

$$d / ( b - a ) \times 100 - 100 = \% overrun$$

wherein:
a=weight of empty cup
b=weight of cup filled with whipped product
d=cup volume.

For determining the foam firmness (force required to penetrate the foam), use was made of a texture analyzer TA-XT2i of Stable Micro Systems with the following settings: speed 1 mm/s, time 15 seconds, measured value: force (in grams) after 10 seconds penetration. The measurement was done in a cup filled with foam and measured within 5 minutes after the product had been whipped. A second firmness measurement was done after 2 hrs. storage in the refrigerator at 4° C.

Next, sensory tests were carried out by a trained panel of 6 persons in which mouthfeel and taste and assessed.

The results are summarized in table 2.

TABLE 2
Functionality and sensory tests.

| | | | Firmness | |
|---|---|---|---|---|
| | Overrun | Firmness | (g) after | |
| | (%) | (g) | 2 h at 4° C. | Sensory description |
| Sample 1 | 165 | 142 | 276 | Creamy taste, cold mouthfeel, |
| | | | | fresh taste, clean palate after |
| | | | | consumption |
| Sample 2 | 274 | 200 | 303 | Milky/creamy taste, cold |
| | | | | mouthfeel, fresh taste, clean |
| | | | | palate after consumption |
| Sample 3 | 301 | 191 | 293 | Milky/creamy taste, cold |
| | | | | mouthfeel, fresh taste, clean |
| | | | | palate after consumption |
| Reference | 274 | 282 | 345 | Sticky, warm mouthfeel. Remains |
| Monte | | | | for a long time in the mouth |
| DP570 | | | | during consumption |
| Dairy | 84 | 205 | 194 | Milky/creamy taste, mouthfeel cold |
| Cream | | | | and creamy, dissolves quickly from |
| | | | | the palate and does not give a |
| | | | | sticky mouthfeel |

### Example 3

Test with various emulsifiers.

Five different emulsifiers were tested, and a different concentration of the alpha tending emulsifier as compared to samples 1, 2 and 3 from example 1. In table 3 below, the compositions of the final products are given:

TABLE 3
Composition of whipping agents with various emulsifiers.

| Ingredient | Sample | | | | | | |
|---|---|---|---|---|---|---|---|
| (wt. %) | A | B | C | D | E | F | G |
| Glucose | 37.2 | 35.3 | 37.2 | 37.2 | 37.2 | 37.2 | 39.7 |
| syrup DE32 | | | | | | | |
| Lactose | 9.0 | 9.0 | 9.0 | 9.0 | 9.0 | 9.0 | 9.0 |
| Sweet whey | 9.0 | 9.0 | 9.0 | 9.0 | 9.0 | 9.0 | 9.0 |
| permeate | | | | | | | |
| Lactem | 3.0 | 6.0 | | | | | |
| Palm | 14.4 | 13.5 | 14.4 | 14.4 | 14.4 | 14.4 | 14.4 |
| kernel oil | | | | | | | |
| GMO | 1.0 | 2.0 | 1.0 | 1.0 | 1.0 | 1.0 | 1.0 |
| Soy lecithin | | | 3.0 | | | | |
| Datem | | | | 3.0 | | | |
| Citrem | | | | | | 3.0 | |
| SSL | | | | | 3.0 | | |
| Tween 80 | | | | | | | 0.5 |
| K₂HPO₄ | 1.0 | 1.0 | 1.0 | 1.0 | 1.0 | 1.0 | 1.0 |
| Sodium | 3.2 | 3.2 | 3.2 | 3.2 | 3.2 | 3.2 | 3.2 |
| caseinate | | | | | | | |
| Coconut oil | 20.7 | 19.5 | 20.7 | 20.7 | 20.7 | 20.7 | 20.7 |
| Moisture | 1.5 | 1.5 | 1.5 | 1.5 | 1.5 | 1.5 | 1.5 |

Glucose syrup, Sodium caseinate, coconut oil, palm kernel oil, Lactem and GMO were obtained from the same suppliers as mentioned in the preparation method of sample 1 in Example 1.

Soy lecithin (de-oiled lecithin powder) was obtained from Cargill.

Datem (Panodan 517), Citrem N12, SSL P 55 were obtained from Dupont Danisco. Tween 80 (ADMUL T80K) was obtained from Kerry.

Datem is diacetyl tartaric acid ester of mono- and diglycerides; Citrem is citric acid esters of mono- and diglycerides of fatty acids, SSL is Sodium stearoyl lactylate, Tween 80 is polysorbate 80.

The preparation method for the samples A-G was essentially the same as described for sample 1, with the difference that Lecithin, Datem, SSL and Tween 80 were added to the water phase, not to the fat phase.

It appeared that Citrem did not very easy dissolve in the fat phase and caused a lot of foam on the fat phase. The final emulsion to be dried was thicker than the emulsion used for invention (Sample A).

Sample B was with the alpha-tending emulsifier but with a concentration outside the claimed range.

The process with lecithin caused drying problems and a lot of product had to be sieved, and resulted in a coarse, yellowish product.

The process with Datem produced a very thick emulsion and additional water had to be added.

The process with SSL produced an even thicker emulsion as compared to Datem, and even more water had to be added to obtain a processible emulsion.

The process with the Tween 80 emulsifier was done at a level of 0.5 wt. % because of expected emulsion instability at 3 wt. % dosage. Even with 0.5 wt. % it resulted in a very thin, unstable emulsion, showing fat separation and caseinate aggregation.

Functionality test of Samples A-G.

Whipping experiments with samples A-G were carried out as described in example 2. Overrun was determined directly after whipping, and firmness after 5 minutes.

A sensory test was carried out with a group of 6 persons. Results are shown in table 4.

It appeared that samples C-G did not show any functionality whatsoever; with these compositions it was not possible to prepare a whipped product as no overrun was created, and therefore no firmness could be measured. A sensory test was therefore not deemed necessary.

TABLE 4
Functionality test samples A and B.

| | Sample A | Sample B |
|---|---|---|
| Overrun (%) | 268 | 258 |
| Firmness (grams) | 179 | 259 |
| Sensory/taste profile | Creamy taste, cold | Sticky, warm mouthfeel. |
| | pleasant mouthfeel, | Fatty taste lingering |
| | fresh taste, clean palate | long in the mouth, |
| | after consumption, | typical taste and |
| | quickly melting in the | mouthfeel of a topping |
| | mouth. | prepared with |
| | | conventional instant |
| | | whipping agent. |

From this example it can be concluded that the compositions of samples C-G are unsuitable as whipping agents. Furthermore, it shows that alpha-tending emulsifiers in amounts in whipping agents higher than used in accordance with the invention still show unacceptable results; these still have the sensory properties of whipped toppings made with the conventional whipping agents.

From the experiments it can be concluded that with the whipping agents of the invention, a very good overrun and firmness can be achieved. This surprising effect that despite a much lower amount of alpha tending emulsifier in the whipping agent as compared to conventional whipping agents, whipping agents of satisfactory functionality can be obtained, has never been observed in the art. In addition, on the sensory aspect, a clear improvement has been achieved when compared to conventional whipping agents. Use of the whipping agents according to the invention results in a foam with sensory attributes on mouthfeel (stickiness, melting behavior during consumption) and taste (milkiness, creaminess) that are much closer to those of whipped dairy cream, and further away from conventional whipping agents.

1. A powdered whipping agent suitable for preparing a whipped topping, the whipping agent comprising, by weight of the whipping agent:
(a) 20-57 wt. % fat or oil or mixtures thereof;
(b) 1.0-5.5 wt. % of an alpha-tending emulsifier selected from the group consisting of lactic acid esters of mono- and/or diglycerides of fatty acids, acetic acid esters of mono- and/or diglycerides of fatty acids, propylene glycol monostearate, and mixtures thereof;
(c) 0.2-2.0 wt. % of nonionic mono- and/or diglycerides of fatty acids having at least one acyl chain of 14-20 carbon atoms;
(d) 1.0-5.0 wt. % proteinaceous emulsifier;
(e) 25.5-75.0 wt. % carbohydrates; and
(f) 0.1-4.0 wt. % moisture.

2. The powdered whipping agent according to claim 1, wherein the nonionic mono- and/or diglycerides of fatty acids having at least one acyl chain of 14-20 carbon atoms comprise an unsaturated acyl chain.

3. The powdered whipping agent according to claim 1, wherein the nonionic mono- and/or diglycerides of fatty acids having at least one acyl chain of 14-20 carbon atoms comprise a saturated acyl chain.

4. The powdered whipping agent according to claim 1, wherein more than 80 wt. % of the fat or oil comprises vegetable fat or oil, or mixtures thereof.

5. The powdered whipping agent according to claim 4, wherein the vegetable fat or oil is selected from the group consisting of palm oil, palm kernel oil, coconut oil, palm kernel stearin, sunflower oil, rapeseed oil, soybean oil, corn oil, shea oil, and/or mixtures thereof.

6. The powdered whipping agent according to claim 1, wherein the weight/weight ratio of the fat or oil to the alpha-tending emulsifier is 10 or higher.

7. The powdered whipping agent according to claim 1, wherein the weight/weight ratio of the fat or oil to the alpha-tending emulsifier is 30 or lower.

8. The powdered whipping agent according to claim 1, further comprising:
(g) 0.1-1.5 wt. % of additional components selected from the group of stabilizers, hydrocolloids, flavoring agents and coloring agents, and combinations thereof.

9. The powdered whipping agent according to claim 1, wherein at least 50 wt. % of the proteinaceous emulsifier is a milk protein or a plant protein or combinations thereof.

10. The powdered whipping agent according to claim 1, wherein the carbohydrates comprise lactose.

11. A method for preparing a powdered whipping agent according to claim 1, comprising:
(a) preparing a mixture of water and fat or oil or mixtures thereof, alpha-tending emulsifier, nonionic mono- and/or diglyceride of fatty acids having at least one acyl chain of 14-20 carbon atoms, proteinaceous emulsifier, carbohydrates, and optionally other components;
(b) homogenizing the mixture to obtain an emulsion; and
(c) spray drying the emulsion to obtain the powdered whipping agent.

12. The method according to claim 11, wherein the carbohydrates comprise a source of lactose.

13. The method according to claim 12, wherein the source of lactose comprises 60-100 wt. % lactose by weight of the source of lactose.

14. A method for preparing a whipped food product having an overrun of 100-400%, comprising whipping the composition of claim 1 in a food acceptable liquid.

15. A whipped food product comprising the powdered whipping agent according to claim 1.

16. The whipped food product according to claim 1, wherein the food is a dessert, cake or pie filling, ice cream filling, crème Chantilly, or mousse.
